(19) United States
(12) Patent Application Publication
(10) Pub. No.: US 2020/0094733 A1
(43) Pub. Date: Mar. 26, 2020

(54) Illuminated EV light for electric and hybrid cars and trucks

(71) Applicant: Michael Pine, Boynton beach, FL (US)

(72) Inventor: Michael Pine, Boynton beach, FL (US)

(21) Appl. No.: 16/136,477

(22) Filed: Sep. 20, 2018

(51) Int. Cl. B60Q 1/50; B60Q 1/04; B60Q 1/24; H05B 37/02

(52) U.S. Cl. CPC B60Q 1/50; H05B 37/02; B60Q 1/24; B60Q 1/0408

(57) ABSTRACT

Illuminated electric/EV mode light for electric and hybrid cars and trucks. A light illuminated outside the vehicle denoting EV mode and indicating when the vehicle is in electric/EV mode. External light installed, mounted or integrated into existing lighting housings or car/truck designs. Light mounted or installed outside the vehicle is connected to existing or new EV source trigger or original source to signal when vehicle is in electric/EV mode. When vehicle enters EV mode the exterior light either mounted, integrated or installed is illuminated from the source indicator control. This light may denote words or letters representing EV mode in the form of a light or symbol. Installed either during original manufacturing of the vehicle or after the vehicle is manufactured.

### SUMMARY

Illuminated electric/EV mode light for electric and hybrid cars and trucks. A light illuminated outside the vehicle denoting EV mode and indicating when the vehicle is in electric/EV mode. External light installed, mounted or integrated into existing lighting designs for cars/trucks. Examples of such devices, installed, mounted or illuminated symbols by way of light emanating from new or existing designs such as taillights.

### BRIEF DESCRIPTION

This patent provides that a light or any other device that will be illuminated or denoted outside the vehicle denoting EV mode and indicating when the vehicle is in electric/EV mode.

### DETAILED DESCRIPTION

An indication EV/electric mode light may or may not currently be part of existing designs, which indicate when vehicle is in EV/electric mode.

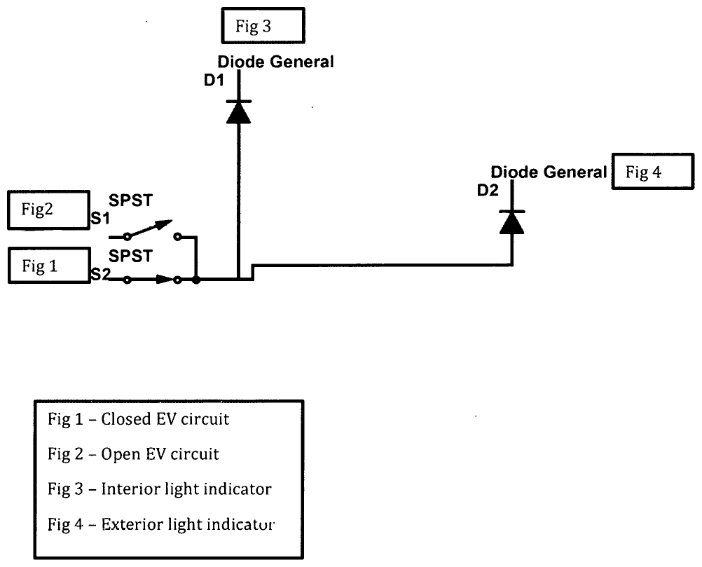

FIG. 1: indicates when vehicle enters EV/electric mode.

FIG. 2: indicates when vehicle is not in EV/electric mode.

FIG. 3: is the interior indicator, which operates when vehicle is in EV/electric mode.

FIG. 4: is the indicator outside the vehicle to indicate when the vehicle is in EV/electric mode.

### BACKGROUND

The invention pertains generally to electrical connections and components. More specifically, the invention relates to an electrical connection to existing or new connections, which indicate when the vehicle enters EV/electric mode. The connector includes a unique a connection, which performs the key functions. The invention possesses numerous benefits and advantages over current available solutions and differs from what currently exists. This invention is an improvement on what currently exists. Currently there are no other solutions in the world designed or installed on any current vehicles EV or otherwise. Because of its flexibility and simplicity in installation and use, the invention can easily be implemented.

1. Object of the invention: an EV indication light, mounted or integrated into the exterior of the car, truck or other electric/motorized vehicle, comprising of illuminated light or lights or symbols by way of light emanating from new or existing designs such as taillights, means of adapting existing or part of new manufacturing can be easily adapted and enabled to any motorized vehicle, electric or hybrid vehicle.
